(19) United States
(12) Patent Application Publication
(10) Pub. No.: US 2017/0129447 A1
(43) Pub. Date: May 11, 2017

(54) AIRBAG AND AIRBAG APPARATUS

(71) Applicant: TAKATA CORPORATION, Tokyo (JP)

(72) Inventors: Yusuke TAKEBAYASHI, Tokyo (JP); Atsushi FURUTA, Tokyo (JP)

(73) Assignee: TAKATA CORPORATION, Tokyo (JP)

(21) Appl. No.: 15/340,514

(22) Filed: Nov. 1, 2016

(30) Foreign Application Priority Data
Nov. 11, 2015 (JP) 2015-221373

(51) Int. Cl. B60R 21/276; B60R 21/268; B60R 21/205; B60R 21/26; B60R 21/235; B60R 21/239

(52) U.S. Cl. CPC B60R 21/276; B60R 21/235; B60R 21/239; B60R 21/205; B60R 21/26; B60R 21/268; B60R 2021/0048

(57) ABSTRACT

In one embodiment, a passenger-side airbag is inflated and deployed between a passenger's seat and an instrument panel. The airbag includes an airbag body; and a patch cloth provided on an outer surface of a forward part of the airbag body. A side patch cloth provided on respective side parts of the airbag body has a slit.

### CROSS REFERENCE TO RELATED APPLICATION

This application is based upon and claims benefit of priority from the Japanese Patent Application No. 2015-221373, filed on Nov. 11, 2015, the entire contents of which are incorporated herein by reference.

### FIELD

The present invention relates to an airbag and an airbag apparatus for restraining a passenger in an automobile or the like in the event of collision or the like. The forward-backward/top-bottom/left-right directions referred to in the present invention correspond to the forward-backward/top-bottom/left-right directions of the vehicle, unless otherwise specified.

### BACKGROUND

There are known airbag apparatuses that each restrain the body of a passenger by inflating an airbag at a relevant position around the passenger by using an inflator in the event of collision, rollover, or the like of a vehicle such as an automobile. For example, a passenger-side airbag apparatus is stored in the instrument panel, and an airbag thereof is inflated and deployed in case of an emergency, thereby restraining the passenger in the passenger's seat.

Regarding passenger-side airbag apparatuses, some proposals have been made in which a patch cloth is provided on the outer surface of a forward part of the airbag so that the forward part of the airbag is reinforced.

### BRIEF DESCRIPTION OF THE DRAWINGS

FIG. 1 is a side view of an airbag apparatus according to an embodiment.

FIG. 2A is a bottom view of the airbag according to the embodiment, FIG. 2B is a side view of the airbag according to the embodiment, and FIG. 2C is a top view of the airbag according to the embodiment.

FIG. 3 is a side view of the airbag according to the embodiment that has been deployed without being inflated.

FIG. 4 is a top view of an airbag according to another embodiment.

### DETAILED DESCRIPTION

In one embodiment, a passenger-side airbag is inflated and deployed between a passenger's seat and an instrument panel. The airbag includes an airbag body; and patch cloths provided on an outer surface of a forward part of the airbag body. Side patch cloths provided on respective side parts of the airbag body each have a slit.

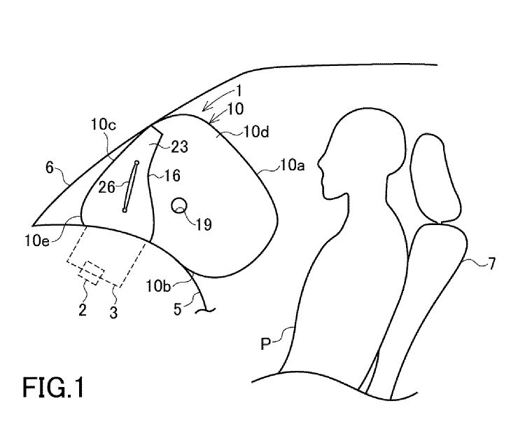

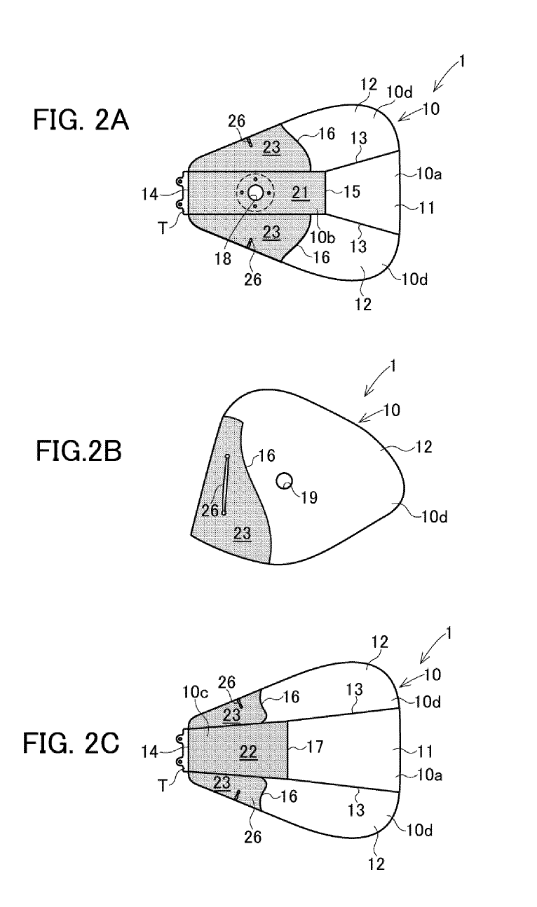

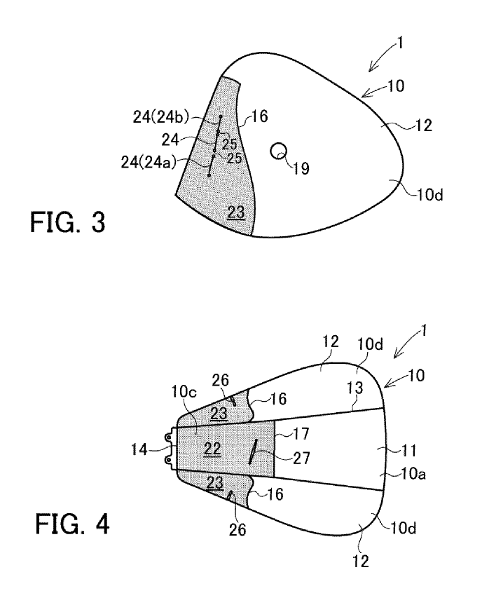

Referring to FIGS. 1 to 3, an airbag apparatus according to an embodiment of the present invention will now be described. FIG. 1 is a side view of the airbag apparatus when an airbag according to the embodiment has been inflated and deployed. FIG. 2A is a bottom view, FIG. 2B is a side view, and FIG. 2C is a top view of the airbag illustrated in FIG. 1. FIG. 3 is a side view of the airbag according to the embodiment that has been deployed without being inflated.

The airbag apparatus according to the present embodiment includes an airbag 1 that is folded at normal times but is inflated and deployed in case of an emergency, an inflator 2 that supplies gas to the airbag 1, a retainer 3 that fixes the airbag 1 and the inflator 2, and so forth. The airbag apparatus is a so-called passenger-side airbag apparatus and is stored in an instrument panel 5 provided in front of a passenger's seat 7. The airbag 1 is inflated and deployed in a space surrounded by a passenger P, the instrument panel 5, and a windshield 6.

The inflator 2 has a substantially columnar outer shape and has a gas ejection port in a side peripheral surface at a distal end thereof positioned in the airbag 1. The inflator 2 is fitted in an opening provided in the retainer 3 and is fixed to the retainer 3 with fixing means such as a bag ring.

The airbag 1 includes an airbag body 10, a lower patch cloth 21 provided at a bottom part 10b of the airbag body 10, an upper patch cloth 22 provided at a top part 10c of the airbag body 10, and side patch cloths 23 provided at respective side parts 10d of the airbag body 10. The lower patch cloth 21, the upper patch cloth 22, and the side patch cloths 23 cover the outer surface of a forward part of the airbag body 10.

The airbag body 10 is inflated and deployed substantially in front of the passenger P. A front part 10a of the airbag body 10 faces the passenger P. The top part 10c of the airbag body 10 extends from a proximal end 10e, which is across from the passenger P, along the windshield 6 to the upper side of the front part 10a. The bottom part 10b extends from the proximal end 10e along the upper surface of the instrument panel 5 to the lower side of the front part 10a. The pair of side parts 10d cover two respective sides of an area surrounded by the front part 10a, the bottom part 10b, and the top part 10c.

FIGS. 2A to 2C illustrate a state where the airbag 1 removed from the airbag apparatus illustrated in FIG. 1 has been inflated and deployed. In FIGS. 2A to 2C, the airbag 1 is not fixed to the retainer 3. Therefore, the shape of the airbag 1 that has been inflated and deployed in FIGS. 2A to 2C is different from the shape illustrated in FIG. 1.

The airbag body 10 includes, for example, a center panel 11 including a set of the front part 10a, the bottom part 10b, and the top part 10c; and a pair of side panels 12 sewed to two respective sides of the center panel 11 and including the side parts 10d. The center panel 11 and the side panels 12 are sewed together at sewed parts 13, and two ends of the center panel 11 are sewed together at a sewed part 14, whereby a bag member is provided.

In FIGS. 2A to 2C, the lower patch cloth 21, the upper patch cloth 22, and the side patch cloths 23 are solidly shaded as a matter of convenience of description. The arrangement of the panels forming the bag member of the airbag body 10 is not limited to the arrangement illustrated in the drawings, and any panel arrangement employed in the known art may be employed.

As illustrated in FIG. 2A, the bottom part 10b of the center panel 11 is provided with the lower patch cloth 21. Two sides of the lower patch cloth 21 are sewed to the airbag body 10 at the respective sewed parts 13. The front (forward) end of the lower patch cloth 21 is sewed to the airbag body 10 at the sewed part 14. The rear (backward) end of the lower patch cloth 21 is sewed to the center panel 11 at a sewed part 15. Furthermore, an inflator opening 18 into which the inflator 2 is inserted is provided in the bottom part 10b of the center panel 11 and the lower patch cloth 21.

The two ends of the center panel 11 have respective positioning tabs T. The tabs T are put together and are fixed to each other with pins, whereby the airbag body 10 is fixed so that the predetermined sewing work is performed.

As illustrated in FIG. 2B, the side panels 12 are provided with the respective side patch cloths 23. The side patch cloths 23 are sewed to the airbag body 10 at the sewed parts 13 as illustrated in FIGS. 2A and 2C, with the rear (backward) ends thereof sewed to the side panels 12 at respective sewed parts 16 as illustrated in FIGS. 2A to 2C. A vent hole 19 is provided in each of the side panels 12 on the rear (backward) side with respect to a corresponding one of the sewed parts 16.

As illustrated in FIG. 2C, the top part 10c of the center panel 11 is provided with the upper patch cloth 22. Two sides of the upper patch cloth 22 are sewed to the airbag body 10 at the sewed parts 13. The front (forward) end of the upper patch cloth 22 is sewed to the airbag body 10 at the sewed part 14. The rear (backward) end of the upper patch cloth 22 is sewed to the center panel 11 at a sewed part 17.

The lower patch cloth 21, the upper patch cloth 22, and the side patch cloths 23 are made of the same material as, for example, the base fabric forming the airbag body 10 (the center panel 11 and the side panels 12). The base fabric is a woven fabric made of, for example, polyamide thread, polyester thread, or the like, and one side thereof is coated with a coating agent such as silicon. The outer surfaces of the lower patch cloth 21, the upper patch cloth 22, and the side patch cloths 23, i.e., the surfaces on the side opposite the side facing the airbag body 10, are the coated surfaces. Each one of the lower patch cloth 21, the upper patch cloth 22, and the side patch cloths 23 is made of at least one piece of base fabric. The lower patch cloth 21, the upper patch cloth 22, and the side patch cloths 23 may be made of one piece of base fabric.

As illustrated in FIG. 3, the side patch cloths 23 each have a plurality of slits 24 provided at intervals. The slits 24 are arranged on one straight line.

The fabric forming each of the side patch cloths 23 includes first thread and second thread that are woven orthogonally to each other. The slits 24 each extend along one of the first thread and the second thread that is at a smaller angle with respect to the sewed part 16 at the edge of the side patch cloth 23 on the vehicle rear side. In other words, the slits 24 each extend along one of the first thread and the second thread that is closer to being parallel to the sewed part 16.

The lower end of a slit 24a that is at the lowest position among the plurality of slits 24 is on the outside of the instrument panel 5 (above the instrument panel 5) in the state where the airbag 1 has been inflated and deployed.

The slits 24 are provided near the center of the side patch cloth 23 in the forward-backward direction and in the left-right direction.

It is preferable to provide a circular hole at each of the lower end of the slit 24a that is at the lowest position among the plurality of slits 24 and the upper end of a slit 24b that is at the highest position among the plurality of slits 24.

The inflator 2 is fitted into the inflator opening 18 of the airbag 1 configured as above and into the opening of the retainer 3, and the inflator 2 is fixed to the retainer 3, together with the airbag 1, with fixing means such as a bag ring. The airbag 1 is folded, and the folded body is put into the retainer 3. Thus, the airbag apparatus is provided.

In the present embodiment, providing the plurality of short slits 24 prevents the side patch cloths 23 from rolling up from the slits 24 when the airbag 1 is folded. Hence, folding of the airbag 1 is easier than in a case of providing one long slit.

If an automobile equipped with the above airbag apparatus has a collision, the inflator 2 is activated and the gas is supplied into the airbag body 10 from the inflator 2, whereby the airbag body 10 comes out of the instrument panel 5. The forward part of the airbag body 10 is covered with the lower patch cloth 21, the upper patch cloth 22, and the side patch cloths 23 and is therefore protected from peripheral members such as the instrument panel 5. Furthermore, since the outer surfaces of the lower patch cloth 21, the upper patch cloth 22, and the side patch cloths 23 are coated surfaces, the airbag 1 is smoothly deployed.

After the airbag 1 comes out of the instrument panel 5, bridge parts 25 provided between the slits 24 are cut with the inflation and deployment of the airbag 1, whereby the plurality of slits 24 are connected to one another and form one slit 26 illustrated in FIGS. 1 and 2A to 2C. With the slit 26, the stress applied to the sewed part 16 is eased.

The slit 26 extends along the thread forming the side patch cloth 23. The circular holes provided at the upper end and the lower end of the slit 26 serve as stoppers. Hence, the slit 26 can be provided at a desired position.

The lower end of the slit 26 is at a higher position than the upper surface of the instrument panel 5. Therefore, even if the slit 26 is widely opened, the side patch cloth 23 that is interposed between the side part 10d of the airbag body 10 and peripheral members such as the instrument panel 5 protects the side part 10d.

FIG. 4 is a top view of an airbag according to another embodiment. As illustrated in FIG. 4, the upper patch cloth 22 may have one or a plurality of slits 27. With such a slit 27, the stress applied to the sewed part 17 at the inflation and deployment of the airbag 1 is eased.

The present invention is not limited to the above embodiments. Various changes can be made to the embodiments without departing from the scope of the present invention, of course.

What is claimed is:

1. A passenger-side airbag that is inflated and deployed between a passenger's seat and an instrument panel, the airbag comprising:
an airbag body; and a patch cloth provided on an outer surface of a forward part of the airbag body,
wherein a side patch cloth provided on respective side parts of the airbag body has a slit.

2. The airbag according to claim 1, wherein the slit includes a plurality of slits that are arranged on one straight line and at intervals.

3. The airbag according to claim 2, wherein, when the airbag is inflated and deployed, bridge parts provided between the plurality of slits are cut.

4. The airbag according to claim 1, wherein, when the airbag is inflated and deployed, the slit is positioned outside the instrument panel.

5. The airbag according to claim 1, wherein the side patch cloth has, on an outer side opposite a side facing the airbag body, a coated surface coated with a coating agent.

6. The airbag according to claim 1,
wherein the side patch cloth includes first thread and second thread that are woven orthogonally to each other, and
wherein the slit extends along one of the first thread and the second thread that is at a smaller angle with respect to a sewed part where an edge of the side patch cloth on a vehicle backward side and the airbag body are sewed together.

7. The airbag according to claim 1, further comprising an upper patch cloth provided at a top part of the airbag body,
wherein the upper patch cloth has a slit.

8. An airbag apparatus comprising:
an airbag that is inflated and deployed between a passenger's seat and an instrument panel, including an airbag body, and a patch cloth provided on an outer surface of a forward part of the airbag body; and
an inflator that supplies gas to the airbag body,
wherein a side patch cloth provided on respective side parts of the airbag body has a slit.
